(19) United States
(12) Patent Application Publication
(10) Pub. No.: US 2014/0200757 A1
(43) Pub. Date: Jul. 17, 2014

(54) ONBOARD SYSTEM, ELECTRONIC KEY SYSTEM, AND CONTROL UNIT

(71) Applicant: KABUSHIKI KAISHA TOKAI RIKA DENKI SEISAKUSHO, AICHI (JP)

(72) Inventors: Isshu KOJIMA, Aichi (JP); Akihito KIMURA, Aichi (JP); Tadayuki TOBIMATSU, Aichi (JP); Keiji YAMAMOTO, Aichi (JP); Takashi IEDA, Aichi (JP)

(21) Appl. No.: 14/147,660

(22) Filed: Jan. 6, 2014

(30) Foreign Application Priority Data
Jan. 11, 2013 (JP) 2013-003680

(51) Int. Cl. B60L 11/18

(52) U.S. Cl. CPC B60L 11/1809
USPC 701/22

(57) ABSTRACT

An onboard system includes a switch arranged on a vehicle at a location allowing for a user to operate the switch from outside the vehicle. A control unit allows for a vehicle power supply to be switched OFF if an operation performed on the switch is detected when a power supply plug is connected to a charge inlet.

### CROSS-REFERENCE TO RELATED APPLICATIONS

This application is based upon and claims the benefit of priority from prior Japanese Patent Application No. 2013-003680, filed on Jan. 11, 2013, the entire contents of which are incorporated herein by reference.

### BACKGROUND

The present invention relates to an onboard system that controls an onboard device.

A vehicle, such as a hybrid vehicle or an electronic vehicle, includes a battery and a motor driven by the battery. A power plug is connected to a charge inlet of the vehicle to charge the battery.

Japanese Laid-Open Patent Publication No. 2009-17653 describes an onboard controller that switches the vehicle to a charge mode when the connection of a power plug to the charge inlet is detected. To keep the vehicle still when the battery is being charged, the onboard controller stops the engine if the engine is running and prohibits starting of the engine if the engine has already been stopped.

### SUMMARY

In the '653 publication, when switching the vehicle to the charge mode, the onboard controller switches OFF the power supply of the vehicle in addition to stopping the engine. Under this control, when the vehicle battery is being charged, the user of the vehicle cannot use a power terminal that is provided in the vehicle to charge a non-onboard device such as a portable device. Further, the use of onboard electrical equipment such as the vehicle air conditioner may be disabled.

It is an object of the present invention to provide an onboard system that allows for the user to switch the power supply of the vehicle ON and OFF when a power plug is connected to the charge inlet.

One aspect of the present invention is an onboard system including a switch arranged on a vehicle at a location allowing for a user to operate the switch from outside the vehicle. A control unit allows for a vehicle power supply to be switched OFF if an operation performed on the switch is detected when a power supply plug is connected to a charge inlet.

Another aspect of the present invention is an electronic key system for a vehicle including a motor, the electronic key system comprising an electronic key; and a control unit that controls a power supply of the vehicle. The control unit includes an I/O port configured to receive a connection notification signal from a plug connection detector and an operation switch from a switch, wherein the connection notification signal is output from the plug connection detector to notify the control unit that a power plug has been connected to a charge inlet to charge a battery that drives the motor, and an operation signal is output from the switch to notify the control unit that an operation has been performed on the switch arranged proximal to the charge inlet from outside the vehicle, and a control circuit that switches OFF the power supply of the vehicle when the connection notification signal and the operation signal are both received.

An aspect of the present invention is a control unit for an electronic key system of a vehicle including a motor. The control unit includes an I/O port and a control circuit. The I/O port is configured to receive a connection notification signal from a plug connection detector and an operation switch from a switch, wherein the connection notification signal is output from the plug connection detector to notify the control unit that that a power plug has been connected to a charge inlet to charge a battery that drives the motor, and an operation signal is output from the switch to notify the control unit that an operation has been performed on the switch arranged proximal to the charge inlet from outside the vehicle. The control circuit is configured to switch OFF a power supply of the vehicle when the connection notification signal and the operation signal are both received.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram illustrating one embodiment of an onboard system;

FIG. 2A is a plan view showing a vehicle including the system of FIG. 1 when the vehicle battery is being charged; and

FIG. 2B is a partially enlarged view of FIG. 2A.

### DESCRIPTION OF EMBODIMENT

One embodiment of an onboard system will now be described.

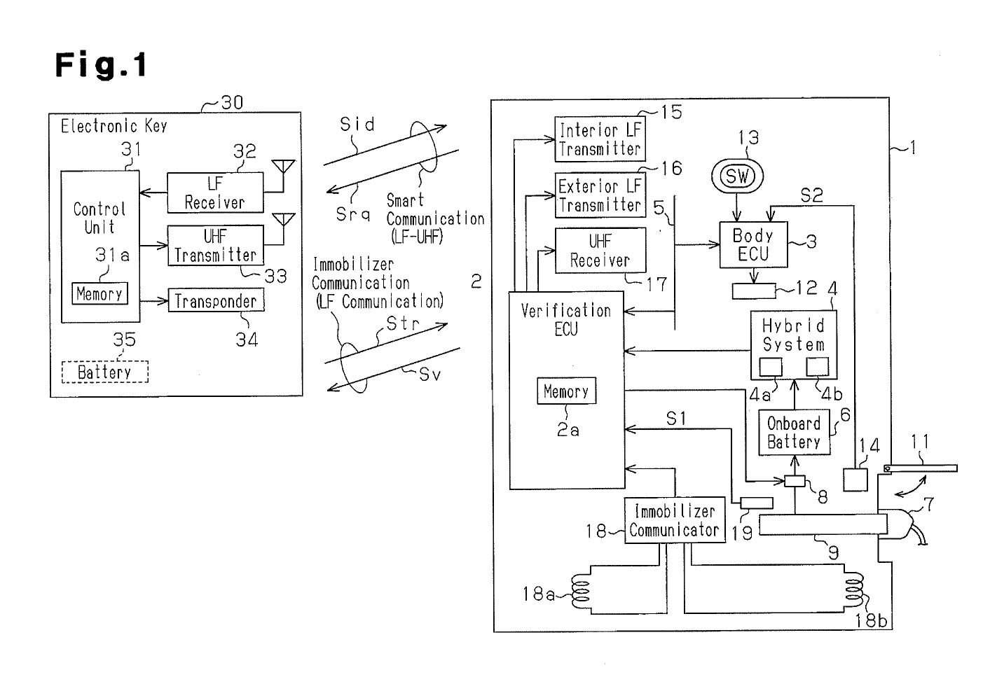

Referring to FIG. 1, a hybrid vehicle 1 performs wireless communication with an electronic key 30. The wireless communication switches the vehicle doors between locked and unlocked states. The wireless communication also switches the vehicle 1 between a driving restricted state and a driving permitted state. Further, the wireless communication switches a power plug 7 between locked and unlocked states.

As shown in FIG. 1, the electronic key 30 is typically powered by an incorporated battery 35. The electronic key 30 includes a control unit 31 that manages communication operations of the electronic key 30. The control unit 31 includes a memory 31a to which a key ID is registered. An LF receiver 32, which receives radio waves on the low frequency (LF) band, and a UHF transmitter 33, which transmits radio waves on the ultrahigh frequency (UHF) band, are connected to the control unit 31.

Further, the electronic key 30 includes a transponder 34. The transponder 34 includes a coil and an IC chip. The vehicle 1 includes an immobilizer communicator 18 that transmits drive radio waves Sv to the electronic key 30. When the transponder 34 receives the drive radio waves Sv, the transponder 34 is driven by induced electromotive force that is generated at the coil. The driven transponder 34 transmits, through wireless communication, a transponder response signal Str that includes the key ID.

The vehicle 1 includes a verification electronic control unit (ECU) 2, a body ECU 3, and a hybrid system 4 (hybrid power train system). The hybrid system 4 drives the vehicle 1 with the power of the engine 4a or the power of the motor 4b or by combining the power generated by the engine 4a and the motor 4b. The verification ECU 2, the body ECU 3, and the hybrid system 4 are connected to one another by, for example, a bus 5 and configure an in-vehicle local area network LAN). The vehicle 1 includes an onboard battery 6 that drives the motor 4b. The verification ECU 2 and the body ECU 3 configure one example of a control unit for the onboard system.

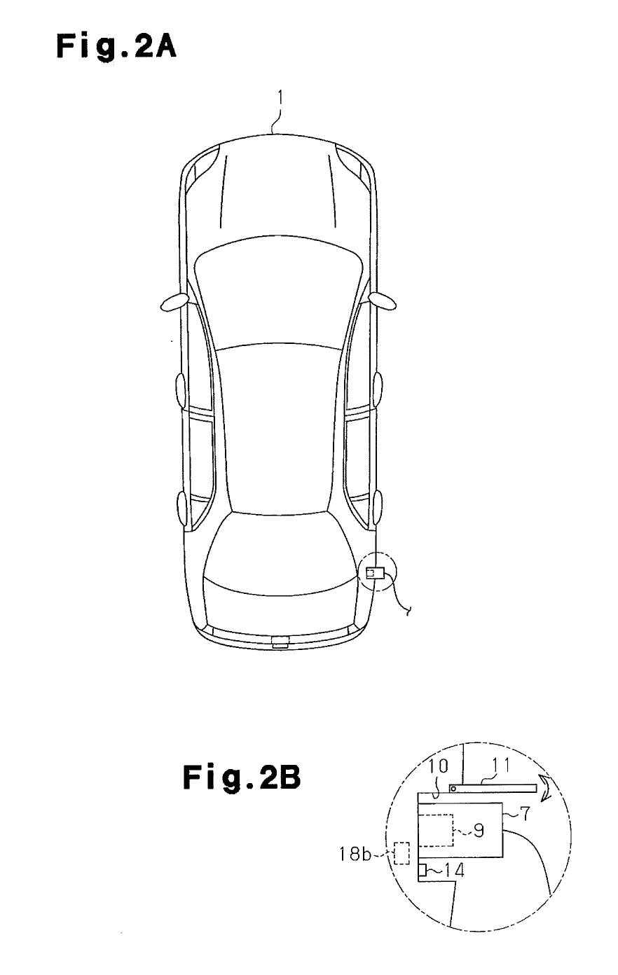

Referring to FIG. 2A, the vehicle 1 has a charge inlet 9, for example, at a side wall (in detail, wall located toward the rear from the rear right door). A power plug 7 is connected to the charge inlet 9 to charge the onboard battery 6. As shown in FIG. 2B, the charge inlet 9 includes a power port 10, which may be a recess formed in the side wall of the vehicle 1. A charge lid 11 closes the power port 10 and conceals the charge inlet 9. In the example illustrated in FIG. 1, the charge lid 11 is moved in the directions shown by the arrows. The charge lid 11 opens when, for example, a lid open lever (not shown) arranged near the drive seat is manually operated.

When the charge lid 11 is open, the power plug 7 may be connected to the charge inlet 9. Connection of the power plug 7 to the charge inlet 9 allows for the onboard battery 6 to be charged under the control of a charge control unit 8.

The body ECU 3 is connected to a door lock device 12, a system switch 13, and a switch 14. The system switch 13 is, for example, a push switch and arranged in the passenger compartment near the driver seat. When the system switch 13 is pushed, the system switch 13 provides the body ECU 3 with an electric signal.

Referring to FIG. 2B, the switch 14 is arranged near the charge inlet 9, preferably, in the power port 10. The switch 14 is, for example, a push type switch. When the switch 14 is pushed, the switch 14 provides the body ECU 3 with an electric signal (operation signal).

As shown in FIG. 1, the verification ECU 2 includes a memory 2a that stores the key ID of the registered electronic key 30. The verification ECU 2 is connected to an interior LF transmitter 15, an exterior LF transmitter 16, a UHF receiver 17, the immobilizer communicator 18, and a plug connection detector 19.

The immobilizer communicator 18 includes two coil antennas 18a and 18b, each functioning as a transmission-reception antenna. The coil antenna 18a is arranged near the system switch 13. The coil antenna 18b is arranged near the charge inlet 9, preferably, in the power port 10.

When the vehicle 1 is in a park state (vehicle power supply OFF), the verification ECU 2 transmits a request signal Srq, which may be an LF band wireless signal, from the exterior LF transmitter 16 out of the vehicle 1. The verification ECU 2 receives an ID signal Sid from the electronic key 30 in response to the request signal Srq with the UHF receiver 17. The verification ECU 2 verifies the key ID included in the ID signal Sid with the key ID registered to the memory 2a (exterior smart verification). When exterior smart verification is accomplished, the verification ECU 2 provides the body ECU 3 with a verification accomplishment signal. When receiving the verification accomplishment signal, the body ECU 3 permits unlocking of the vehicle doors or drives the door lock device 12 to unlock the vehicle doors.

After exterior smart verification is accomplished, when the body ECU 3 detects the opening and closing of a vehicle door, the verification ECU 2 transmits a request signal Srq to the passenger compartment from the interior LF transmitter 15. When interior smart verification is accomplished, upon receipt of a signal from the body ECU 3 indicating operation of the system switch 13, the verification ECU 2 switches the power supply of the vehicle 1 from a park state (vehicle power supply OFF) to a driving permitted state (vehicle power supply ON). In the driving permitted state, activation of the hybrid system 4 is permitted.

When the battery 35 of the electronic key 30 is drained and normal ID verification cannot be performed, the user may unlock a vehicle door with a mechanical key provided in the electronic key 30. When the verification ECU 2 detects a predetermined sequence of operations, which may be the unlocking of a vehicle door with the mechanical key followed by the depression of a brake pedal, the verification ECU 2 activates the immobilizer communicator 18 and transmits transponder drive radio waves Sv from the coil antennas 18a and 18b.

The coil antenna 18a of the immobilizer communicator 18 receives a transponder response signal Str from the electronic key 30 that is located in the passenger compartment. The verification ECU 2 verifies the key ID included in the transponder response signal Str with the key ID registered to the memory 2a (transponder verification). When transponder verification is accomplished and the verification ECU 2 recognizes pushing of the system switch 13, the verification ECU 2 permits starting of the hybrid system 4 and switches the power of the vehicle from a vehicle power supply OFF state to a vehicle power supply ON state.

When the power plug 7 is connected to the charge inlet 9, that is, when the verification ECU 2 receives an ON signal S1 from the plug connection detector 19, the verification ECU 2 provides the charge control unit 8 with a charge initiation command. The ON signal S1 of the plug connection detector 19 may be referred to as a connection notification signal.

There may be a case in which the vehicle power supply is ON before battery charging is started but the user wishes to switch OFF the vehicle power supply after starting battery charging (i.e., after connecting the power plug 7 to the charge inlet 9). Further, there may be a case in which the user forgets to switch OFF the vehicle power supply. In such cases, the user may operate the switch 14 to switch OFF the vehicle power supply from outside the vehicle 1.

The switch 14 will now be described. For example, the power plug 7 may be connected to the charge inlet 9 when the vehicle power supply is ON. In this case, the verification ECU 2 receives an ON signal S1 from the plug connection detector 19, activates the immobilizer communicator 18, and starts transmitting transponder drive radio waves Sv from the coil antennas 18a and 18b.

Then, the user brings the electronic key 30 to a location near the charge inlet 9 so that the distance from the charge inlet 9 allows for the electronic key 30 to receive the transponder drive waves Sv from the coil antenna 18b. In response to the transponder radio waves Sv from the coil antenna 18b, the electronic key 30 transmits a transponder response signal Str. The verification ECU 2 receives the transponder response signal Str via the coil antenna 18b and the immobilizer communicator 18 and executes transponder verification. Then, if the verification ECU 2 recognizes that the switch 14 has been pushed when transponder verification is accomplished, the verification ECU 2 switches OFF the vehicle power supply. In this manner, when transponder verification is accomplished during battery charging, the user may push the switch 14 to switch OFF the power supply of the vehicle 1.

The onboard system of the above embodiment has the advantages described below.

(1) During the charging of the onboard battery 6 (charge mode), if the verification ECU 2 recognizes that the switch 14 has been pushed, the verification ECU 2 switches OFF the vehicle power supply. This allows for a user located outside the vehicle 1 to switch OFF the vehicle power supply. Thus, if the user starts battery charging when forgetting to switch OFF the vehicle power supply, the user may switch OFF the vehicle power supply without entering the vehicle 1. In the preferred example, the user has to push the switch 14 and hold the electronic key 30 near the charge inlet 9 to switch OFF the vehicle power supply. Thus, the vehicle power supply is not switched OFF if the power plug 7 is connected to the charge inlet 9 when the user inadvertently operates the switch 14 or a person other than the user operates the switch 14 in an unauthorized manner.

(2) The switch 14 and the coil antenna 18b are arranged near the charge inlet 9. This allows for the user to switch ON and OFF the power supply of the vehicle 1 from outside the passenger compartment.

(3) The transponder 34 functions using the transponder drive waves Sv as a power source. Thus, there is no need to use the electric power of the battery 35 for the electronic key 30. Further, the communicable range for transponder communication is smaller than that for smart communication. Thus, the distance between the electronic key 30 and the vehicle 1 has to be small to establish transponder communication. Transponder communication may be performed regardless of whether battery drainage occurs in the electronic key 30. Further, transponder communication is subtly affected by the radio wave environment around the charge inlet 9. Accordingly, the onboard system that implements transponder communication may switch OFF the power supply of the vehicle during the charge mode.

(4) The coil antenna 18b for near-distance wireless communication is arranged in the proximity of the charge inlet 9. When the power plug 7 is connected to the charge inlet, wireless signals (Sv, Str) used for ID verification of the electronic key 30 are transmitted and received via the coil antenna 18b. When ID verification of the electronic key 30 is accomplished, the verification ECU 2 switches OFF the vehicle power supply. This allows for the verification ECU 2 to switch OFF the vehicle power supply as the user intends to.

It should be apparent to those skilled in the art that the present invention may be embodied in many other specific forms without departing from the spirit or scope of the invention. Particularly, it should be understood that the present invention may be embodied in the following forms.

In the illustrated example, the verification ECU 2 and the body ECU 3 are connected by the bus 5. In a further example, the verification ECU 2 and the body ECU 3 may be configured by the same ECU. The verification ECU 2 and the body ECU 3 may include an I/O port, which is configured to receive at least an ON signal S1 of the plug connection detector 19 and an electric signal S2 of the switch 14, and a control circuit, which is configured to switch ON and OFF the power supply of the vehicle in accordance with at least the ON signal S1 and the electric signal S2.

The onboard system may incorporate a power supply plug locking device that locks the charge lid 11 and the power plug.

The coil antenna 18b may be omitted. In a substitutive example, the verification ECU 2 may switch OFF the power supply of the vehicle 1 if the switch 14 is operated when exterior smart verification, which is periodically performed, has been accomplished. This allows for advantages (1) and (2) of the illustrated example to be obtained. Further, since there is no need for the coil antenna 18b, the cost of the onboard system may be reduced. Moreover, during battery charging, even if the switch is pushed again inadvertently, the vehicle power supply is not switched ON. This ensures that the vehicle does not start to move during the charge mode since an inadvertent switch operation does not switch ON the vehicle power supply.

In the above substitutive example, exterior smart verification may be excluded from the conditions for switching ON and OFF the vehicle power supply outside the vehicle 1. For example, during battery charging, the verification ECU 2 may switch OFF the power supply of the vehicle 1. This allows for the power supply of the vehicle 1 to be switched OFF through a simple operation.

The switch 14 may be omitted. In this case, during charging, the verification ECU 2 switches OFF the power supply of the vehicle 1 based on the result of the transponder verification performed with the electronic key 30 and the coil antenna 18b, which is arranged near the charge inlet 9.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise optical disk storages, magnetic disk storages, magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An onboard system comprising:
a switch arranged on a vehicle at a location allowing for a user to operate the switch from outside the vehicle; and
a control unit allowing for a vehicle power supply to be switched OFF if an operation performed on the switch is detected when a power supply plug is connected to a charge inlet.

2. The onboard system according to claim 1, wherein
the control unit verifies a key ID received through wireless communication from an electronic key, and
the control unit permits the power supply to be switched OFF if an operation performed on the switch is detected when the key ID is verified.

3. The onboard system according to claim 1, wherein the switch is used exclusively to switch OFF the vehicle power supply.

4. An electronic key system for a vehicle including a motor, the electronic key system comprising:
an electronic key; and
a control unit that controls a power supply of the vehicle, wherein the control unit includes
an I/O port configured to receive a connection notification signal from a plug connection detector and an operation switch from a switch, wherein the connection notification signal is output from the plug connection detector to notify the control unit that a power plug has been connected to a charge inlet to charge a battery that drives the motor, and an operation signal is output from the switch to notify the control unit that an operation has been performed on the switch arranged proximal to the charge inlet from outside the vehicle, and
a control circuit that switches OFF the power supply of the vehicle when the connection notification signal and the operation signal are both received.

5. The electronic key system according to claim 4, wherein
the control circuit is configured to perform wireless communication and verify the key ID of the electronic key when the connection communication signal is received from the plug connection detector, and
the control circuit is configured to switch OFF the vehicle power supply when the key ID is verified and the operation signal is then received from the switch.

6. A control unit for an electronic key system of a vehicle including a motor, the control unit comprising:
an I/O port configured to receive a connection notification signal from a plug connection detector and an operation switch from a switch, wherein the connection notification signal is output from the plug connection detector to notify the control unit that that a power plug has been connected to a charge inlet to charge a battery that drives the motor, and an operation signal is output from the switch to notify the control unit that an operation has been performed on the switch arranged proximal to the charge inlet from outside the vehicle, and
a control circuit that switches OFF a power supply of the vehicle when the connection notification signal and the operation signal are both received.

7. The control unit according to claim 6, wherein
the control circuit is configured to perform wireless communication to verify a key ID of an electronic key when the connection notification signal is received from the plug connection detector, and
the control unit is configured to permit the power supply to be switched OFF when the key ID is verified and the operation signal is then received from the switch.

8. The control unit according to claim 7, wherein the wireless communication includes transmission of transponder drive radio waves and reception of a transponder response signal including the key ID of the electronic key.

9. The control unit according to claim 6, wherein the switch is a power supply OFF switch.
